(19) United States
(12) Patent Application Publication
(10) Pub. No.: US 2007/0132898 A1
(43) Pub. Date: Jun. 14, 2007

(54) Light transmission based liquid crystal temperature sensor

(75) Inventors: Ann M. Anderson, Scotia, NY (US); Timothy Roth, Fullerton, CA (US); Smitesh Bakrania, Ann Arbor, MI (US)

Correspondence Address: NIXON PEABODY, LLP, 401 9TH STREET, NW, SUITE 900, WASHINGTON, DC, 20004-2128, US

(73) Assignee: UNION COLLEGE, Schenectady, NY (US)

(21) Appl. No.: 11/590,906

(22) Filed: Nov. 1, 2006

Related U.S. Application Data
(60) Provisional application No. 60/733,186, filed on Nov. 4, 2005.

(51) Int. Cl. G02F 1/133; G01K 11/00

(52) U.S. Cl. 349/21; 374/161

(57) ABSTRACT

A light transmission based liquid crystal temperature sensor system comprising a layer of thermochromic liquid crystals and a light source for transmitting an amount of light through the layer of thermochromic liquid crystals. A temperature control device records and measures at least one of the amount and spectral characteristics of the light transmitted through the layer of thermochromic liquid crystals. A processing device converts the measured amount or spectral characteristics of the transmitted light to temperature.

### BACKGROUND OF THE INVENTION

1. Field of the Invention

The present invention relates to a transmission based system for measuring temperature using thermochromic liquid crystals and more particularly to a sensor that uses light transmission instead of light reflection to detect temperature.

2. Description of the Related Art

Thermochromic liquid crystals (TLCs) are materials that change their molecular structure and optical properties with temperature. While in their liquid crystal phase (the active range), the TLCs align to form a helical structure. The liquid crystal phase occurs between a highly ordered crystalline phase at low temperature and a highly disordered liquid phase at higher temperature, i.e. between the event and clearing point temperatures. The reflected light distribution from the crystals arises because the crystals align at relative angles to form the helical structure. The pitch of the helix, a function of temperature, determines the wavelength of light that is reflected or transmitted. As the pitch changes so does the wavelength of the light that is reflected or transmitted. The temperature range in which a particular TLC material will react this way is called the active range. In the active range, TLCs reflect or transmit a wavelength distribution that is a function of temperature.

Light reflection is the current method used in thermochromic liquid crystal temperature measurement. The hue of the colors displayed by the liquid crystals can be used to determine the temperature. Hue is calculated from the red, green and blue intensity values and represents the dominant wavelength of color. Correlating the hue or color of the reflected light with temperature is a standard technique used in liquid crystal thermography

TLCs must be calibrated to relate color to temperature. In a calibration experiment a temperature controlled material's surface is painted black, and then coated with TLCs. A digital or CCD camera is positioned over the surface. A light source is used to illuminate the TLC surface and the reflected light is captured by the camera. The material is heated over a range of temperatures, corresponding to the active range of the TLCs, and the CCD camera records images of the surface for every temperature. See U.S. Pat. Nos. 6,783,368; 6,153,889; 5,165,791; 5,972,715; 5,526,148 and 5,653,539, all of which disclose methods and apparatus for measuring the temperature profile of the surface when the surface is covered with a TLC coating and the reflectants of the TLC measured with the use of a CCD or other color camera.

The main disadvantage of the reflection technique is that the calibrations are very sensitive to lighting effects. This includes how much light, the lighting type and the viewing angle and it can be difficult to obtain uniform lighting over the TLC surface. It is often necessary to calibrate the surface in the same environment where the temperature measurements are to be made. In addition, the “calibratable” range of the TLCs is generally only 25 to 50% of their active range. It also has been reported that liquid crystals exhibit hysteresis when heated above their clearing point temperatures. See, D. Birrell and J. Eaton, Liquid Crystal Temperature Measurement For Real-Time Control, Applications of Digital Image Processing XXI, Proc. SPIE 3460, (1998), J. Baughn et al, Hysteresis of Thermochromic Liquid Crystal Temperature Measurement Based in Hue, J. Heat Transfer 212, 1067-1072 (1999), and/or Bakrania and Anderson A Transient Technique for Calibrating ThermoChromic Liquid Crsytals: The Effects of surface Preparation, Lighting and Overheat, Proceedings of IMECE'02:2002 ASME International Mechanical Engineering Congress & Exposition New Orleans, La., (2002). Under hysteresis conditions the intensity of the color is greatly reduced and the calibration curve shifts. However, once the crystals are cooled below the event temperature the crystals generally return to their original behavior. See, C. Smith et al, Temperature Sensing With Thermochromic Liquid Sensors, Experiments in Fluids 30, 190-201 (2001).

The light transmission properties of liquid crystals are used extensively in liquid crystal display technology. Light transmission characteristics of liquid crystals have been measured as a function of applied voltage for liquid crystal display applications. See, for example, H. Birecki and F. Kahn, The Optics of Twisted Nematic Liquid Crystal Displays, J. Appl. Phys. 51(4), 1950-54 (1980). However, very little work has been done to characterize the light transmission characteristics of thermochromic liquid crystals.

One study reports measurements of the amount of transmitted light through polymer stabilized and polymer dispersed cholesteric liquid crystals. A monochromatic light with cross polarization was used. A modulation in the intensity of transmitted monochromatic light with temperature change was observed and it was reported that this activity occurs over a wide range (outside active range) of the liquid crystals. It was concluded that it would be possible to develop an “on-off” type temperature sensor. See, G. Diankov et al., Polymer-stabilized Liquid Crystal Indicator Used in Thermometry, J. of Materials Science: Materials in Electronics 14(10), 831-2 (2003).

In a further study, the color of transmitted light was compared to the color of reflected light through the same polymer dispersed cholesteric liquid crystals. The results show a larger change in “color” of the reflected light from which they conclude light reflection techniques are best. However, the study did not address any of the issues presented above and presented very little information about the actual spectra of transmitted light. See, P. Pavlova et al, Temperature Dependance of Chromaticity in Polymer-dispersed Cholesteric Liquid Crystal: Reflection and Transmission Characteristics, J. Optoelec. Adv. Mat., 7(1), 285-288 (2005).

Thus, there is a need to measure light transmitted through a layer of thermochromic liquid crystals as a function of temperature.

### SUMMARY OF THE INVENTION

One aspect of the present invention is to provide a method and device that uses light transmission to measure temperature with thermochromic liquid crystals (TLCs).

Another aspect of the present invention is to provide a method and device that determines the characteristics of light transmission through thermochromic liquid crystals under conditions of non-polarized, linear polarized and linear cross polarized light; and examine light intensity levels and the effects of the thickness of the liquid crystal layer.

Still yet another aspect of the present invention is to demonstrate a linear relationship between the temperature of the spectra and the transmission characteristics that is applicable over a wide range of temperatures.

According to these and other aspects, there is provided a light transmission based liquid crystal temperature sensor system comprising a layer of thermochromic liquid crystals and a light source for transmitting an amount of light through the layer of thermochromic liquid crystals. A temperature control device records and measures at least one of the amount and spectral characteristics of the light transmitted through the layer of thermochromic liquid crystals. A processing device converts the measured amount or spectral characteristics of the transmitted light to temperature.

These and other features, aspects, and advantages of the present invention will become more apparent from the following detailed description of the preferred embodiment relative to the accompanied drawings, in which:

### BRIEF DESCRIPTION OF THE DRAWINGS

FIG. 1 is a perspective view of a light transmission system according to the present invention.

FIG. 2 is a perspective view of a light reflection measurement system.

FIG. 3 is a graph of the transmission spectra for Surface 1 under linear polarized lighting conditions.

FIG. 4 is a graph of the transmission spectra for Surface 1 under linear cross polarized lighting conditions.

FIG. 5 is a graph of the RGB values for reflected light conditions for Surface 2.

FIG. 6 is a graph of the effect of temperature overheat under linear polarized lighting conditions.

FIG. 7 is a graph of the comparison of the transmission spectra at 36° C. for Surfaces 1, 3 and 4.

FIG. 8 is a graph of a comparison of the transmission spectra at 36° C. for Surface 3 under three different light intensity levels.

FIG. 9 is a graph of the total intensity of transmitted light as a function of temperature for Surfaces 1, 3 and 4.

FIG. 10 is a graph of the intensity of red, green and blue transmitted light as a function of temperature for Surface 3 under linear polarized lighting conditions.

FIG. 11 is a graph of the normalized green signal for Surfaces 1, 3 and 4.

FIG. 12 is a graph of the characteristics of the spectral shape as a function of temperature for Surface 1.

FIG. 13 is a graph of the inflection point wavelength for three light intensity levels on Surface 3 and 100% light on Surface 4.

FIG. 14 is a perspective view of a temperature sensor according to another embodiment of the present invention.

FIG. 15 is a graph of the transmission spectra for Hallcrest R25C10W thermochromic liquid crystals.

FIG. 16 is a graph of predicted red and green signals for green and white electroluminescent lights and halogen light as a function of temperature.

FIG. 17 is the predicted green signal versus temperature for the green electroluminescent light for a thick and thin layer of TLC material.

FIG. 18 is a perspective view of a system for measuring light transmission using different lighting.

FIG. 19A is a graph of the RGB signals for the green electroluminescent light through the thick TLC surface.

FIG. 19B is a graph of the measurements of the green signal through a thick and thin TLC layer with the green electroluminescent light as a function of temperature.

FIG. 19C is a graph of the RGB signal for the white electroluminescent light through the thick TLC surface as a function of temperature.

FIG. 19D is a graph of the RGB signal for the halogen light through the thick TLC surface as a function of temperature.

FIG. 20 is a graph of the effects of overheating on the green signal of the green electroluminescent light as a function of temperature.

FIG. 21 is a graph of the green signal normalized by total intensity at 19° C. for a range of green light intensity levels.

FIG. 22 is a graph of the variations of green signal and camera angle as a function of temperature.

### DETAILED DESCRIPTION OF THE PREFERRED EMBODIMENTS

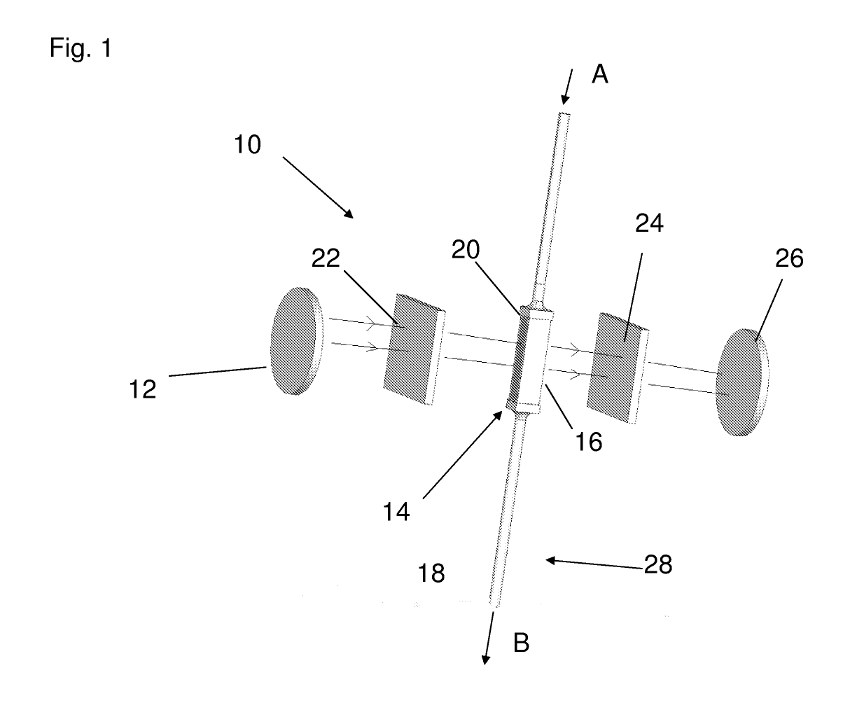

The present invention provides a thermochromic liquid crystal (TLC) temperature measurement system that uses light transmission instead of light reflection. The amount of light transmitted through a layer of thermochromic liquid crystals is a function of temperature. Referring to FIG. 1, the temperature measurement system 10 of the present invention includes a light source 12, such as an organic LED, electroluminescent flexible light panel or other similar technology is used as a light source for the temperature measurement. It should be appreciated that other types of light sources are contemplated by the present invention.

The TLCs 20 are provided on a surface 14. TLCs 20 can be a layer painted, coated or sprayed on surface 14. TLCs 20 can also be provided as a sheet attached to surface 14, a slurry screen printed or an immersion layer, or any other suitable form. The layer of TLC 20 can have a variety of thicknesses, as long as light is able to be transmitted therethrough. TLC 20 can be an ImageTherm 25C10W liquid crystals or Hallcrest R25C10W sprayable liquid crystals. Many other thermochromic liquid crystals are suitable.

According to one embodiment of the present invention, surface 14 can be an outer surface of a cuvette 16. Cuvette 16 can be connected to a temperature control system 28, such as a constant temperature water bath that circulates water through the system during testing. It should be appreciated that other temperature control systems are contemplated by the present invention. As shown in FIG. 1, water from the bath enters at point A and exits at the opposite end B of the cuvette. A thermocouple 18 is located within the cuvette to measure the temperature of the water.

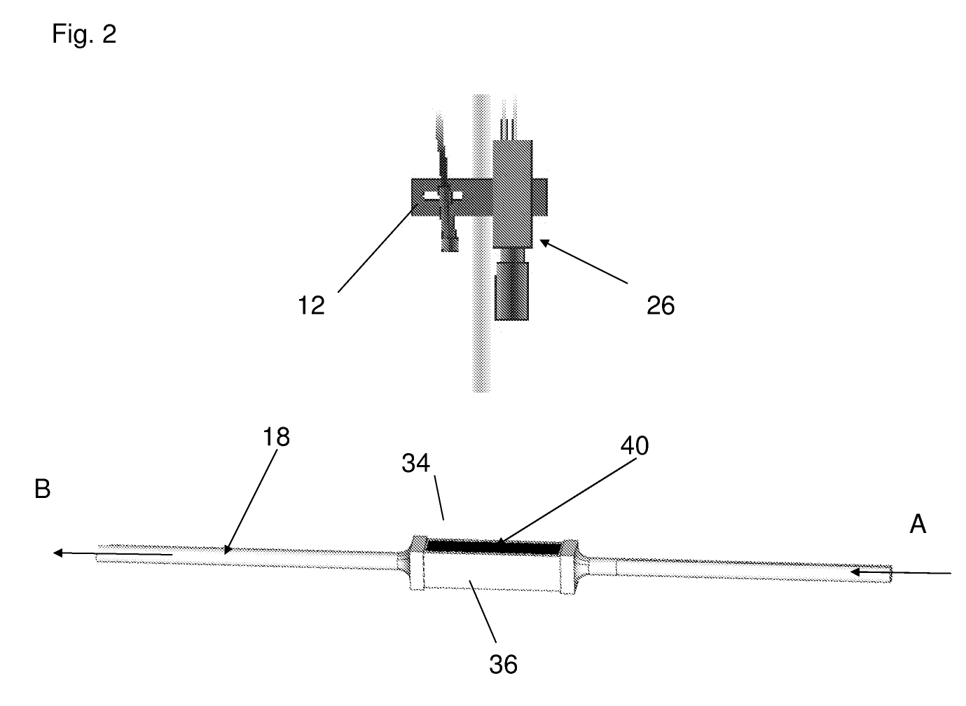

Referring to FIG. 2, in a reflective light system 30, an additional cuvette 36 is provided for the measurement of reflected light. In this test system, TLC material 40 is provided on a surface 34 of cuvette 36. For example, surface 34 can be covered with black paint and then TLC material 40 can be applied as described above.

A processing device 38, such as a microprocessor communicates with CCD camera 26. CCD camera 26 records and measures at least one of the amount and spectral characteristics of the light transmitted through the layer of thermochromic liquid crystals. Microproccesor 38 converts the measured amount or spectral characteristics of the transmitted light to temperature.

Tests were conducted using Hallcrest R25C10W sprayable thermochromic liquid crystals. The liquid crystal material was first microencapsulated by a polymer coating resulting in microcapsules with diameters in the range of 10-15 microns. The resulting slurry was then combined with a water soluble aqueous binder to form a sprayable material. These crystals can have an event temperature of 25° C. (red start) and a bandwidth of 10° C. Tests were performed to measure both the light transmission and the light reflection characteristics of the liquid crystals as described with reference to FIGS. 1 and 2.

Four TLC test surfaces were prepared. The TLCs were applied on one of the four identical outer surfaces of a standard 1 cm path length polystyrene cuvette. The cuvette was connected to the circulating water bath temperature control system.

Surface 1 was used to test polarizing light conditions and overheat effects. Before painting, the TLCs were diluted with water in a 1 to 1 ratio. The mixture was stirred for 15 to 30 minutes and an airbush was used to spray the TLCs onto the one side or face (14) of the cuvette. The remaining three faces were covered to prevent TLC material from getting on the surface and to protect the surface from getting scratched during cuvette preparation. The surface was dried with a heat gun between the application of each coat to ensure that each layer of TLC material dried completely. Approximately 10 coats of TLC material was painted onto the surface. The thickness of the resulting surface was approximately 0.05 mm.

Surface 2 was used for the light reflection tests. The cuvette was airbrushed with black paint before applying the TLC material as described above.

When testing Surfaces 1 and 2 the temperature control system and spectrometer were set up for the transmission tests as shown in FIG. 1. The cuvette was placed in the spectrometer sample holder. Tygon tubing was used to connect the cuvette to a constant temperature water bath which circulated the water through the system during testing. A thermocouple (±1° C.) was located approximately 25 cm downstream of the cuvette to measure the temperature of the water going through the cuvette. This temperature was used as the reference temperature in all of the tests. A one dimensional heat transfer analysis accounting for the convection from the water to the cuvette inner surface, the conduction through the cuvette and liquid crystal surface and convection to the ambient air estimates a maximum temperature difference between the thermocouple and the liquid crystal surface of 0.2° C. (at a water temperature of 27° C.) to 1° C. at (50° C.). The thermocouple temperature measurement was deemed sufficient because the experiment was conducted to measure the transmission characteristics as a function of temperature and not to specifically develop a direct calibration.

Surfaces 3 and 4 were used to study the effect of TLC thickness and light intensity. Calibrated thermocouples were embedded in one side of the cuvette and then diluted TLC material was pored over the thermocouples to form a thicket TLC surface. After allowing the surfaces to dry the layer thickness was measured (for example, using a microscope and set of calipers). The thickness of Surface 3 was measured to be approximately 0.24 mm (±0.03 mm). Surface 4 was measured to be approximately 0.40 mm thick. For both Surfaces 3 and 4, the embedded calibrated thermocouples were used as the temperature reference ((±0.1° C.).

Light transmission characteristics throughout TLCs change with temperature and these changes can be measured. The transmission tests were conducted in a Perkin Elmer Lambda 900 UV/VIS/NIR spectrometer. The spectrometer was equipped with a reference cell which is identical to the sample cell shown in FIG. 1. The reference cell can be used to cancel out any unwanted effects, i.e. like those due to the second polarizing film in the LCP tests or to compare different samples. Equal amounts of light are sent through the sample and reference optics. The amount of light transmitted through the reference cell is taken to be 100% and the percent of light transmission through the sample is referenced to this value.

Transmission spectra were measured under a number of different lighting conditions—non-polarized, linearly polarized, and linear-cross polarized light to illuminate the sample. The effects of temperature overheat were also studied to determine how the hysteresis is manifested in the transmission spectra.

A baseline transmission spectra measured on the unpainted side of each cuvette at 25° C. to account for absorption due to optics, the polarizing film, the cuvette surface and the water. The tests showed a less than 1% shift in transmission through the non-TLC materials over a 30° C. temperature range from 25 to 55° C. A comparison between different sides of the same cuvette showed that the transmission spectra had a maximum variation in transmission of 0.3% for all cuvettes tested. Repeated testing on the same surface showed a maximum variation in transmission level of 0.2% and of 0.35% if repositioning of the cuvette was included.

The transmission spectrum was then measured every 1-2° C. for a range of temperatures from 25 to 55° C. The system was allowed to stabilize for a minimum of 5 minutes at each temperature set point to ensure it reached steady state conditions. Measurements were made for wavelengths from 400 to 700 nm using a 1 nm data interval, a 0.2 sec integration time, a scan speed of 250 nm/min and a slit size of 2 mm. Transmission spectra measurements of the TLC material were repeatable within a 1% transmission level.

For testing linear polarized (LP) conditions a linear polarizing film 22 was placed in the light entry beam path as shown in FIG. 1 and measured the baseline spectra as described above. In this case the baseline spectrum included the polarizing lens to cancel out any “light blockage” effect due to the polarizer and the reference cell was left empty. The tests were performed at the same temperatures as the NP tests, i.e., temperatures ranging from 25° C. to 55° C.

For the linear cross polarized (LCP) light tests the linear polarizer 22 was mounted in the light entry slot as shown in FIG. 1 and a second polarizing film 24 was placed in the receiving end of the spectrometer optics. The second film was placed at an angle to minimize transmission through the system without the cuvette in place. This yielded approximately 0.5% percent transmission. An identical polarizing film was placed in the reference cell to cancel the absorption of the second polarizing film. The cuvette was then placed in the sample cell so the TLCs faced the incoming light. To study the effect of light intensity level a neutral density filter was placed in the incoming beam path. A Thermo Oriel 50490 filter having an 84-86% transmission in the visible range and a 50510 filter having a 49-56% transmission in the visible range was used. The baseline spectra for the tests did not include the neutral density filters because the intention was to change the incoming light intensity.

Temperature overheat effects were studied under LP and LCP lighting conditions. The TLCs were heated from 25° C.-65° C. then cooled back down to 25° C. Spectra were taken at 35 and 45° C. during both the heating and the cooling phase to determine the effect of overheating.

For the light reflection tests, the Surface 2 cuvette surface 34 was painted black paint and then the TLC material was applied with an airbrush as described above. The cuvette was hooked up to the temperature control system and mounted horizontally as shown in FIG. 2. A light detector 26, for example, a Sony XC-003 CCD camera connected to a National Instruments IMAQ PCI-1408 image processing board was provided to acquire images of the surface as it was heated with the hot water control system. A Fostec model 20760 fiber optic light was used to illuminate the TLC surface. Both the camera and the fiber optic light were fitted with polarizing lenses to eliminate reflections while maximizing the transmission of polarized light. Images of the surface were acquired in 1° C. intervals from 25 to 45° C.

The uncertainty in the measurements of light transmission is less than 1% transmission based on repeatability measurements. The uncertainty in the temperature measurement is ±1° C. on Surfaces 1 and 2 and ±0.1° C. on Surfaces 3 and 4. The calculated total, red, green and blue intensities have uncertainty values less than 0.2 a.u. and the uncertainty in inflection point wavelength is less than 2 nm.

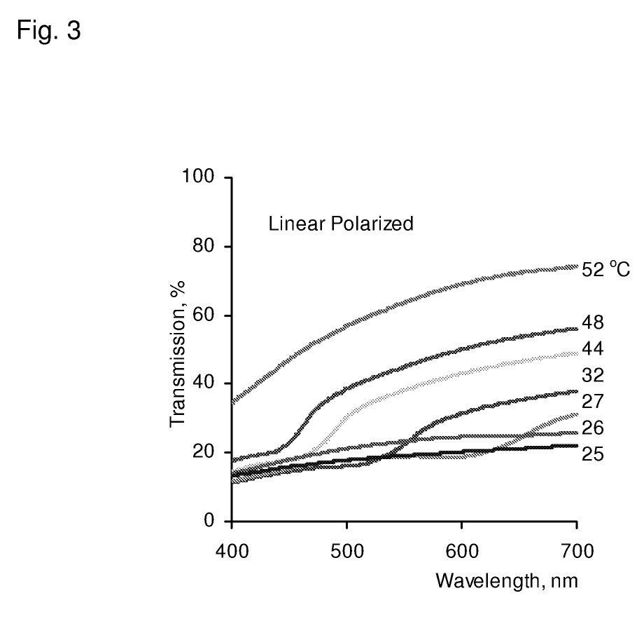

Results of the testing are shown in the graphs of FIGS. 3-11, beginning with the transmission spectra under LP and LCP conditions, which were then compared to the reflection data. Data for characterizing the transmission spectra as a function of temperature is presented, as well. Lastly, the effects of temperature overheat on the transmission spectra is provided.

FIG. 3 shows transmission spectra for linear polarized light through Surface 1 at temperatures from 25 to 52° C. No difference between the transmission spectra for non-polarized and polarized lighting conditions was found, because all baseline spectra included the polarizing filters, so the graph only presents the LP and LCP data. Each line in the figure is an isotherm. As temperature is increased the transmission increases for all wavelengths and for a fixed temperature the transmission increases with increasing wavelength. The lowest transmission levels (10-15%) occur at 25° C. and the highest (35-70%) occur at 52° C.

For a fixed temperature the transmission increases with increasing wavelength. As temperature is increased from 25 to 26° C. the transmission level increases for all wavelengths. From 26 to 27° C. the transmission level decreases for wavelengths less than about 660 nm and increases for wavelengths above this. From 27 to 52° C. the transmission level increases for all wavelengths as temperature is increased. The lowest transmission levels (10 to 15%) occur at the lower end of the active range at 25° C. and the highest (35-70%) occur at 52° C. (above the active range).

Between 27 and 48° C. the spectra exhibit a distinct “in-pattern” s-curve shape. For a given temperature, as wavelength increases from 400 nm there is a relatively small increase in transmission until a “critical” wavelength is reached after which the transmission increases rapidly with wavelength. For example at 32° C., this critical wavelength occurs at about 525 nm. At this point the slope of the spectrum increases. Each spectrum passes through an inflection point and than the slope decreases. This region of high slope or “transmission deficit” shifts to lower wavelengths as temperature increases (i.e., at 48° C. the critical wavelength is about 440 nm. The transmission curve passes through an inflection point and then the rate of increase in transmission with wavelength decreases. This region, of high slope, shifts to lower wavelengths as temperature is increased. At small wavelengths, the effect of temperature (from 25-48° C.) on transmission level is small (a change from 12 to 17% transmission at 400 nm), while at large wavelengths it is more significant (22-56% transmission at 700 nm). More of the higher wavelength (red) light is transmitted for all temperatures. This may be due in part to scattering effects (i.e. the intensity of the scattered light is much higher at small wavelengths).

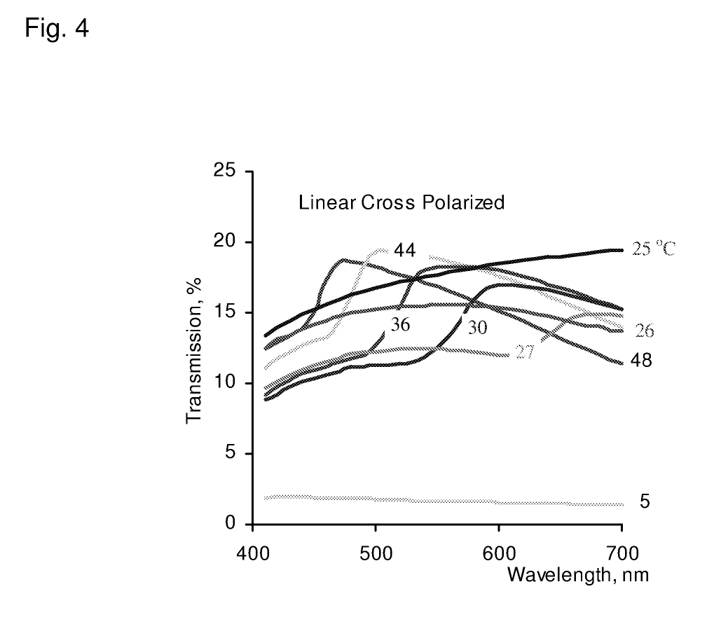

FIG. 4 plots transmission spectra for linear-cross polarized light, wherein the polarizers were aligned for minimum transmission. When the cuvette having the TLC surface is located in the spectrophotometer it polarizes light and allows for some light to be transmitted. At 25° C. the transmission level increases slightly with wavelength and transmits 13-18% of the light. There is a region of temperatures (27-48° C.) for which the spectra exhibit an “in-pattern” shape. At these temperatures the TLCs start to polarize or “twist” the incoming light and allow more light to pass through the second polarizer. For a fixed temperature, the transmission increases slightly with wavelength from 400 nm until a critical wavelength is reached. At this point the slope of the curve increases quickly, as it did for LP light. However, under LCP lighting conditions at a fixed temperature, the transmission level increases with wavelength, reaches a maximum and then decreases. For example, at 36° C. the transmission level increases to approximately 18% at 550 nm and then decreases with increasing wavelength. Above 48° C., which is outside the active range, the crystals transmit very little light. For example, 52° C. spectra levels are around 0.5%. If the LP and LCP spectra are compared at a given temperature, it is found that the inflection points are similar, but the LCP transmission levels are lower, particularly at higher wavelengths.

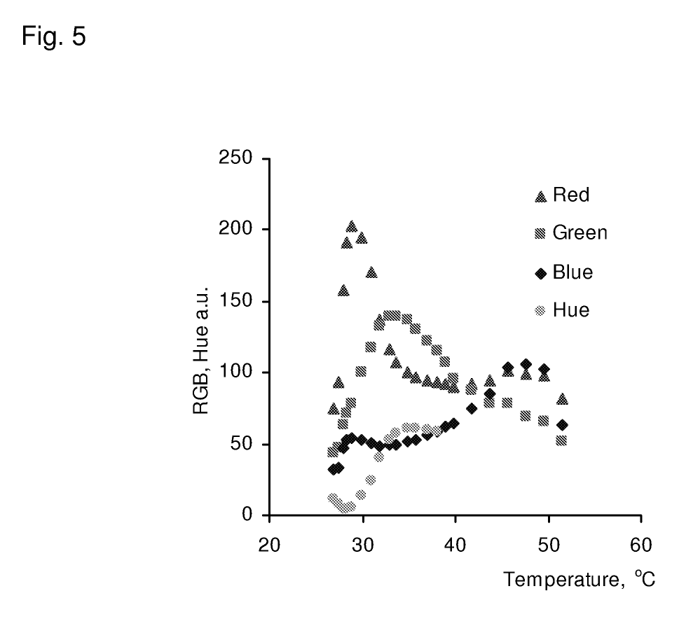

The amount of reflected light from the TLCs as a function of temperature was also measured using the setup described above. The images were analyzed using the MATLAB image processing toolbox. The temperature of the hot water bath circulating system was allowed to reach steady state and images of the surface were acquired every 1-2° C. from 25 to 50° C. These images were then analyzed and the red, green and blue (RGB) components are plotted in FIG. 5. The graph shows that the red component peaks at about 29° C., the green at 33° C. and the blue at 45° C. If the reflection and transmission data is compared it can be seen that the transmission deficit wavelength range for a given temperature corresponds to the reflected RGB data. For example, the transmission deficit region for the 32° C. spectra lies in the 490-580 nm region which implies that the crystals are reflecting in the green range. From FIG. 5, it can be observed that this is near the peak range of the green signal. Likewise, the transmission deficit occurs in the 600-700 nm range for 30° C., which is near the red peak in the reflected data. Hue was calculated and is plotted on the right axis. Hue is monotonic only between 28 and 35° C. which yields a 7° C. calibratable range.

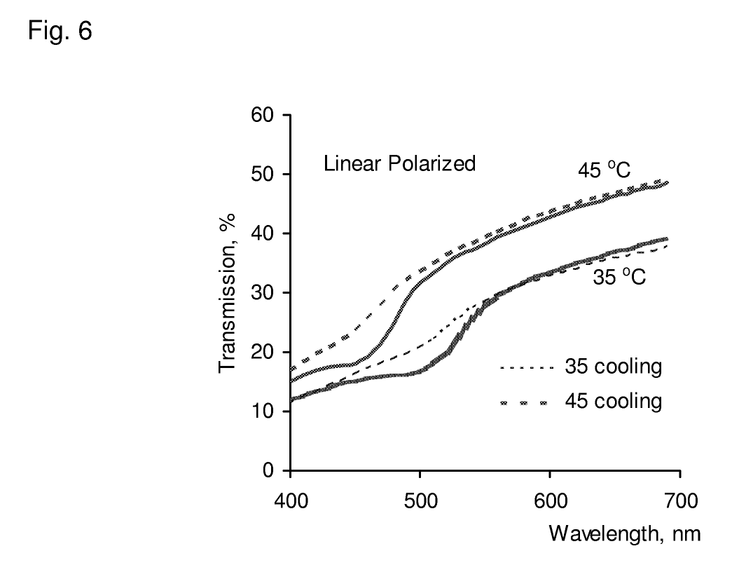

FIG. 6 illustrates the results of temperature overheat on the transmission spectra under LP lighting conditions. Spectra at 35 and 45° C. on heating from 25 and on cooling from 65° C. are plotted for the LP lighting conditions. The spectra exhibit hysteresis. On cooling from 65° C. there is increased transmission between 450 and 550 nm for the 35° C. spectrum and between 400 and 500 nm for the 45° C. spectrum. The effect of overheat is to eliminate the transmission deficit region of the spectra. This corresponds to results seen in reflection tests. It has been shown that the RGB signals are lowered upon overheat. After overheating, the liquid crystals transmit more light and thus reflect less, leading to the lowered RGB values.

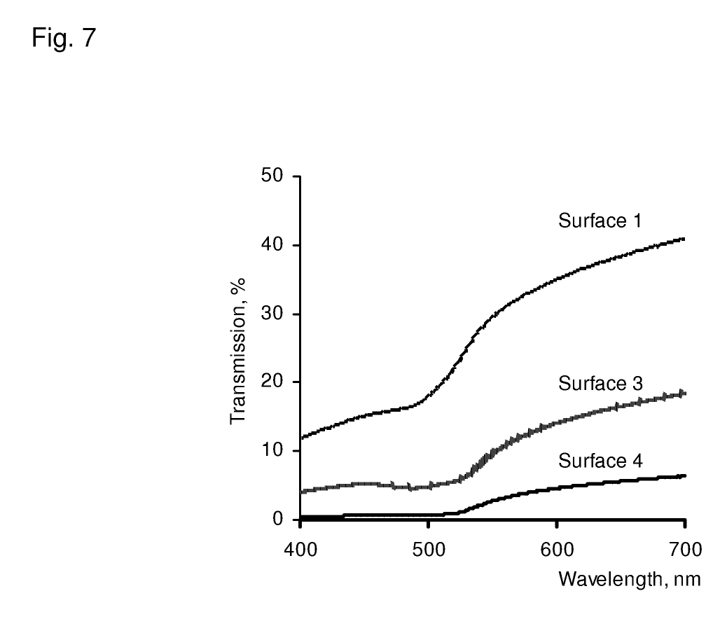

FIG. 7 illustrates spectra for Surfaces 1, 3 and 4 at 36° C. Surface 1 is the thinnest (˜0.05 mm) and Surface 4 is the thickest (˜0.4 mm). As expected, the amount of light transmitted through the surface decreases with increasing thickness. The shape of the spectra are comparable with similar inflection points. However they do not scale. The ratio of the Surface 3 to Surface 4 transmission level is a function of both wavelength and temperature.

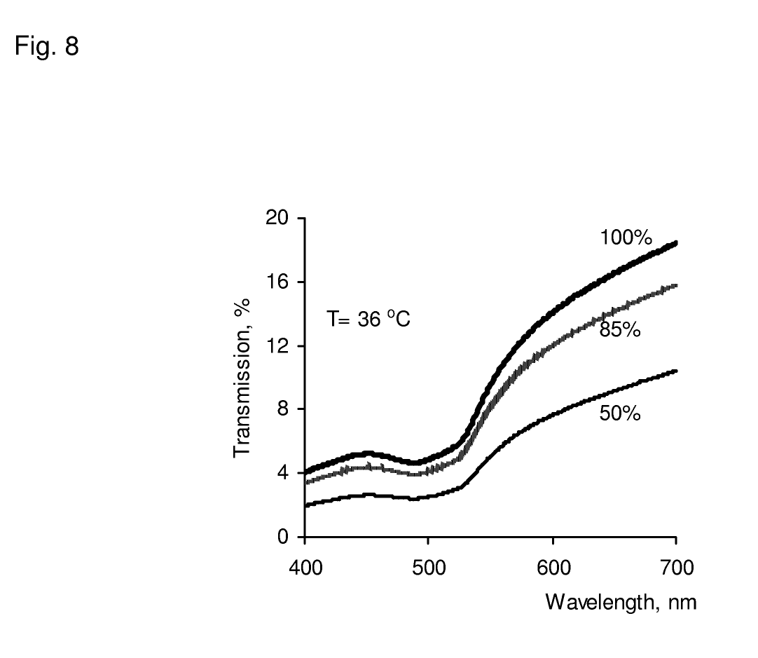

The effects of light intensity were measured using a set of neutral density filters placed in the beam of the incoming light. The filters passed ˜85% and ˜50% of the light over a wavelength range from 400-700 nm. FIG. 8 illustrates the transmission spectra at 36° C. from 400 to 700 nm for 100%, 85% and 50% light transmission. As expected, as the light level decreases the amount of light transmission decreases. The shape of the spectra are similar and scale on the intensity level.

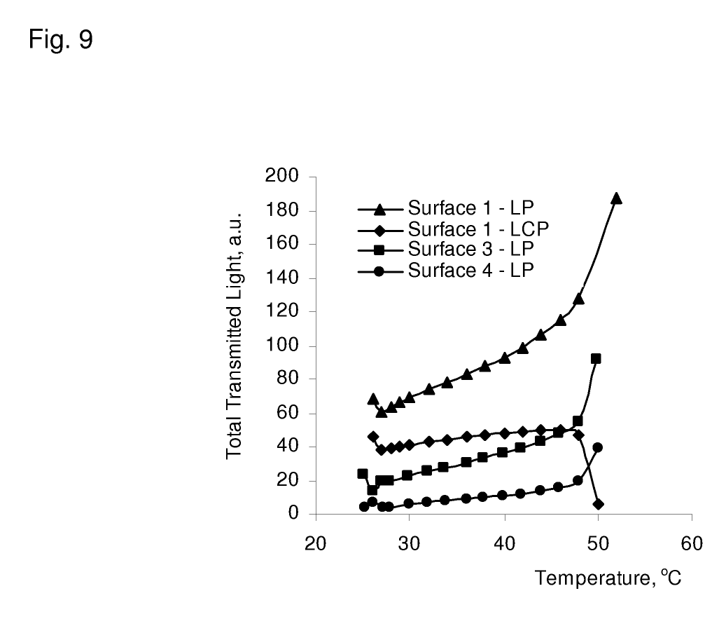

The present invention uses some measure of transmission to calibrate the TLCs as a function of temperature. The measure is dependent on temperature, insensitive to lighting conditions, preferably linear and is applicable over a large temperature range. The total transmission levels, bandwidth transmission levels, and several shape characteristics of spectra were observed. The total transmission is calculated as a function of temperature for wavelengths from 400 to 700 nm. The calculation was performed by summing the transmission percent value (a number between 0 and 1) at every wavelength. FIG. 9 plots the total percent transmission for Surface 1 under both LP and LCP lighting conditions and for Surfaces 3 and 4 under LP lighting conditions as a function of temperature. All 3 surfaces exhibit a linear relationship between total transmitted light and temperatures between 27 and 48° C. This temperature range corresponds to that for which the spectra show in-pattern behavior. The LP data has a higher slope (indicating higher sensitivity) and is more linear (R²=0.995 for LP vs. R²0.948 for LCP). This linear section spans a range that is three times that found for hue in the reflection tests. The three LP tests show a large increase in transmission at 50° C. which is outside the active range. The LCP results show a large decrease at this temperature because the TLCs no longer polarize the light and the cross polarizer cuts out all light.

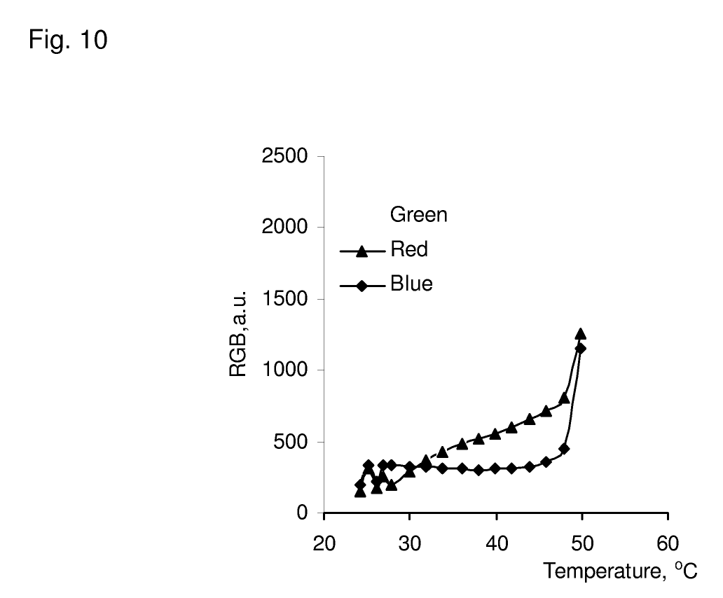

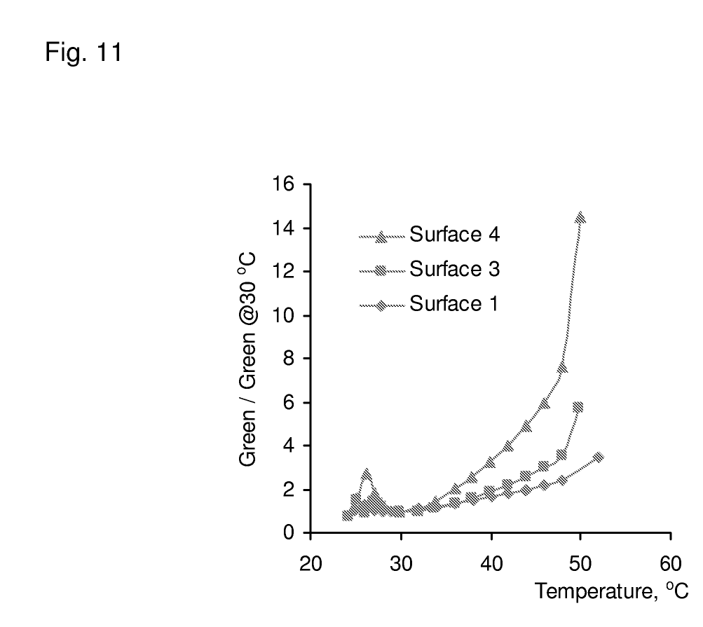

Each spectrum is separated into its red, green, and blue components as a CCD camera would. The liquid crystal transmission spectra is multiplied by the RGB spectral response characteristics of for example, a Sony X003 CCD camera, the total transmission in the blue range calculated (approximately 400-480 nm), the green range calculated (approximately 480-580 nm) and the red range (approximately 580-700 nm). These results are plotted in FIG. 10 for Surface 3. A linear region between 30 and 48° C. can be seen with the green component showing the highest slope. In FIG. 11, a normalized green component versus temperature for Surfaces 1, 3 and 4 is shown. The green component was normalized by the green value at 30° C. so that the sensitivities could be compared. Although the transmission levels are larger for the thinnest surface (Surface 1) the sensitivity of this value to temperature is much higher for the thickest surface (Surface 4) which shows a factor of 7.6 increase over the 18° C. temperature range (versus a factor of 3.5 for Surface 3 and of 2.4 for Surface 1).

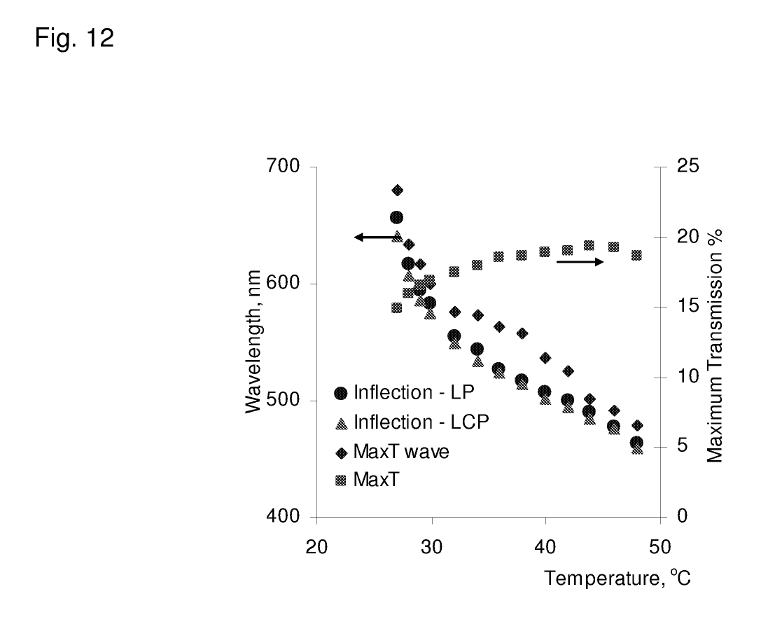

Factors that describe the shape of the spectra were also looked at. The inflection point wavelength (both LP and LCP); the wavelength at which maximum transmission occurs (for the LCP data only); and the maximum transmission level (for the LCP data only) were characterized. These data quantify the leftward shift of the “in-pattern” spectra that occurs with increasing temperature. The uncertainty in estimating the inflection point wavelength is about 2 nm. The results are plotted in FIG. 12 for Surface 1. The LP inflection wavelengths are slightly higher than the LCP values. The inflection point wavelength decreases with temperature (due to the leftward shift in the spectra as temperature increases) and the relationship is fairly linear between 32 and 48° C. where the wavelength decreases from 550 to 450 nm. The wavelength for maximum transmission also decreases with temperature. The wavelength decreases from 675 to 475 nm over the 27 to 38° C. range. There is only a small increase in the maximum transmission value (from 15 to 20%) over the range of temperatures.

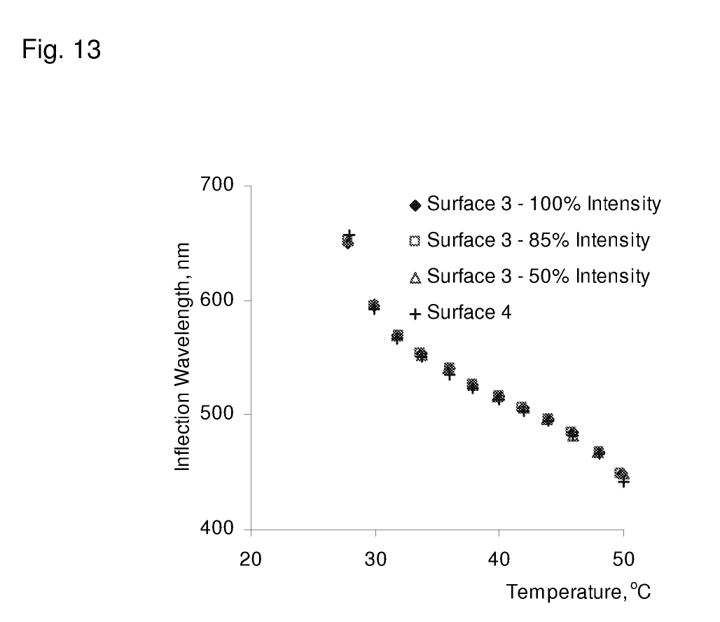

FIG. 13 plots the inflection point data for Surfaces 3 and 4 under LP lighting conditions and with reduced intensity for Surface 3. The data show that the inflection point is not dependent on surface thickness or on light intensity.

There is a large temperature range for which characteristics of the transmission spectra are linearly sensitive to temperature change. The reflection data in FIG. 5 show only a 7° C. range over which the liquid crystals could be calibrated. FIGS. 9 and 10 show that total transmission (intensity), red intensity, green intensity are linear over a 20° C. range for the LP lighting conditions. In addition, the characteristics of the “in pattern” spectra plotted in FIGS. 12 and 13 show significant, linear sensitivity to changes in temperature. Linear-cross polarized light spectra reveal information about the polarizing effect of the crystals but the intensity levels do not change significantly with temperature. The spectral shape characteristics of LCP transmission could possibly be used to measure temperature.

An advantage of using the spectral shape characteristics of inflection point wavelength and maximum transmission wavelength is that they are not sensitive to the incoming light intensity or the thickness of the TLC layer, however they are not easily measured with a CCD camera. The advantage of measuring the overall transmission (intensity) levels is that these are measurements that are easily recorded by a CCD camera. However, the levels will be a function of the light intensity of the source and we may need to address the sort of lighting problems found in reflection tests (angle of light, intensity of light). Preliminary results with a CCD camera show that the effect of light intensity can be normalized out using transmission data from outside the TLC active range.

Overall, for the particular liquid crystal formulation studied it has been found that a measure of light transmission intensity for linearly polarized (or even un-polarized) light through a relatively thick liquid crystal surface is the best measure of temperature. Total, red or green intensity can be used. For the liquid crystals used here (which have a red start temperature) the change in blue intensity appears to be insignificant and is unsuitable as a temperature indicator because there is very little change in the spectra with temperature for wavelengths less than 400 nm as evidenced in the data of FIG. 10.

Referring again to FIG. 11, the effect of TLC layer thickness is illustrated. The overall transmission level is lower for the thick surface and more sensitive to temperature. This suggests that the use of more liquid crystal material will improve the technique. However, this may lead to measurement errors if significant temperature gradients exist across the liquid crystal layer. Estimates for the tests of the thick layer used in this study indicate that the temperature difference across the layer is less than 0.2° C. under worst case conditions. However, in actual applications with high heat transfer rates, this will be larger.

Spatial and temporal resolution are also important characteristics of a temperature measurement system. It can be expected that spatial resolution for the transmission technique would be similar to that seen in reflection methods. The temporal resolution will depend on the thickness of the TLC required for a measurable signal change. Initial results indicate that transmission technique may require thicker surfaces which will decrease temporal resolution.

The lighting configuration inherent in a light transmission measurement offers both advantages and disadvantages, depending on the particular application and its optical accessibility. The use of a sensor that integrates the TLC material with the light source, which could then be mounted directly on a surface of interest is contemplated or the system can use behind-surface lighting.

The TLCs used in the present invention were optimized for use in light reflection temperature measurement methods. TLC formulations that are optimized for transmission response are also contemplated by the present invention. Further development of the light transmission technique could lead to an alternate method for liquid crystal thermography that will complement the existing technique and offer more flexibility in lighting configurations.

There are significant, measurable changes in the amount and pattern of light transmitted through thermochromic liquid crystals as a function of temperature. A light transmission based calibration system offers advantages over the standard light reflection techniques. These advantages include a larger calibration range and less sensitivity to lighting effects. The specific issues under consideration in the development of a CCD based system include accounting for the effect of light source intensity, determining the best type of light source (all of the tests have been conducted with monochromatic light) and the issue of implementing a light transmission set up in an actual experiment.

The present invention demonstrates that between 28 and 48° C. TLCs exhibit large changes in the overall light transmission levels and spectral curve shape. Along with a large temperature change over which the TLCs can be calibrated, the TLC light transmission also offers solutions to the sensitivity to lighting effects found in TLC light reflection.

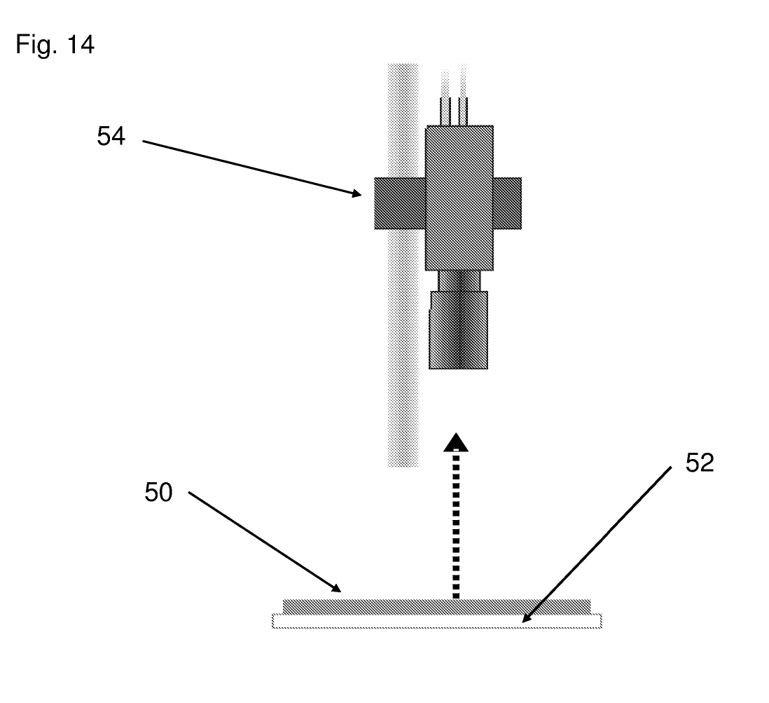

FIG. 14 illustrates another embodiment of a temperature sensing system according to the present invention. As described above, the amount of light transmitted through a layer of thermochromic liquid crystals is a function of temperature.

A variety of different light sources can be used in the temperature sensing system. The ideal light source is one that works well with the TLC material and result in a large linear change in signal over a large temperature range. As discussed supra, a significant change in light transmission occurs in the red and green regions (500-700 nm) of the visible spectrum.

As will be described further herein, it is possible to predict the interaction of different light sources with the TLC material. As shown in FIG. 14, light from a light source 52 passes through a TLC layer 50 that transmits part of that light. That light is then detected by a CCD camera 54.

The layer of thermochromic liquid crystals TLC 50 is applied directly to flexible light source 52. As described supra, TLC 50 can be a layer painted, coated or sprayed on the light source or a sheet attached to surface, a slurry screen printed or an immersion layer, or any other suitable form. The thickness of TLC 50 can be varied, as long as, light can be transmitted therethrough. TLC 50 can be an ImageTherm 25C10W liquid crystal. However, many other thermochromic liquid crystals would be suitable.

Light source 52 and TLC layer 50 form the sensor. The sensor can be mounted on a surface of which the temperature is to be measured. The sensor can have numerous sizes and shapes depending on the particular application. A CCD camera 54 is positioned to record the amount and/or characteristics of light transmitted through TLCs 50 and microprocessor 60 applies calibration relation to convert the information to temperature as described above. The sensor uses light transmission to measure temperature, has a light source that is an integral component of the sensor, and the light source is flexible.

In order to predict the overall red, green and blue signal detected by the CCD camera, the light source intensity spectrum I(λ), the TLC transmission spectrum τ(λ, T), and the CCD camera detection spectrum α_{R,G,B}(λ) can be combined. The light intensity and CCD camera detection are functions only of wavelength (λ), while the transmission of the TLC layer is dependent upon both wavelength (λ) and temperature (T). Although a CCD camera typically has individual gain settings for each of the RGB components, these effects were not included in the analysis.

The product of light intensity, transmission and detection spectra is integrated over the visible wavelength range (400 to 700 nm). The resulting red, green and blue signals, as a function of temperature (T) can be calculated as follows:

$$\begin{matrix}R ( T ) = {\int }_{{λ}_{1}}^{{λ}_{2}} ( I ( λ ) * τ ( λ , T ) * {α}_{R} ( λ ) ) ⅆ λ \\ G ( T ) = {\int }_{{λ}_{1}}^{{λ}_{2}} ( I ( λ ) * τ ( λ , T ) * {α}_{G} ( λ ) ) ⅆ λ \\ B ( T ) = {\int }_{{λ}_{1}}^{{λ}_{2}} ( I ( λ ) * τ ( λ , T ) * {α}_{B} ( λ ) ) ⅆ λ\end{matrix}$$

Three potential light sources were evaluated: a Scott-Fostec halogen light, and a white and green electroluminescent flexible light by Edmund Optics. The spectra of each of these three light sources, I(λ) can be obtained from the manufacturer. The halogen light spectra is linear with maximum intensity at 700 mn. The green electroluminescent light exhibits a single peak at about 525 nm and the white electroluminescent light spectra peaks at 490 and 580 nm.

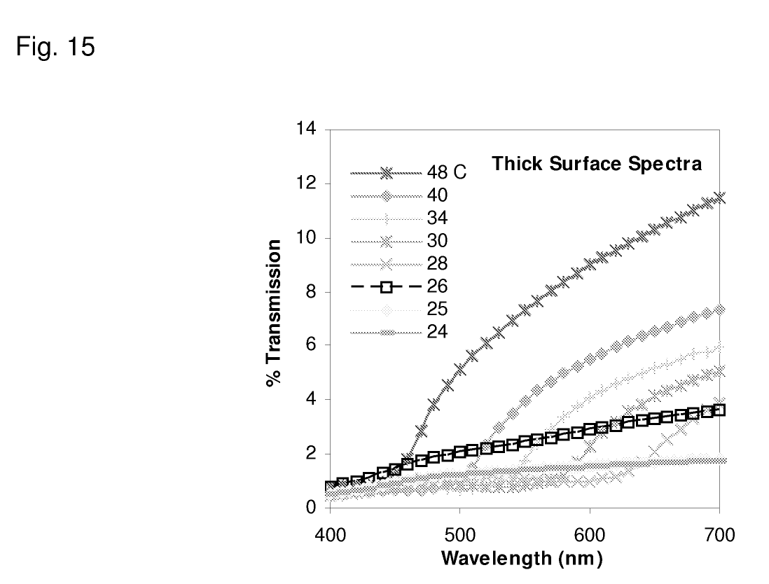

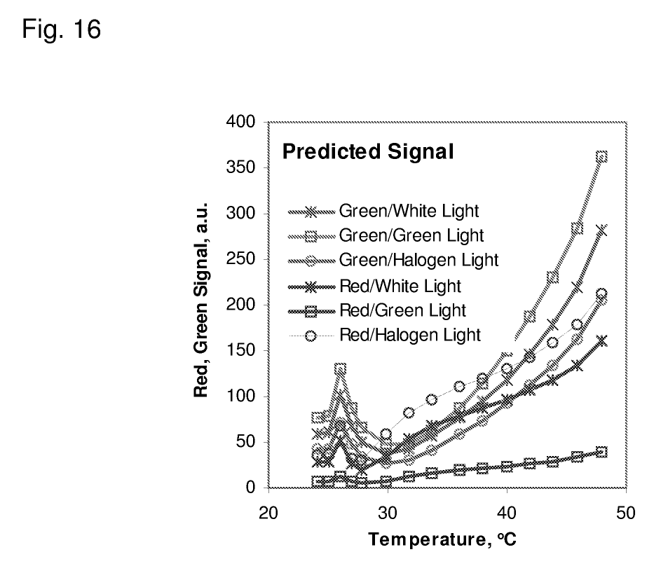

Next, the transmission spectra data of the TLC material τ(λ,T) was acquired. Using a Perkin-Elmer spectrophotometer as described above, for a 0.4 mm thick layer of Hallcrest R25C10W liquid crystal material the transmission data acquired is shown in FIG. 15. These liquid crystals have a published event temperature of 25° C. and a bandwidth of 10° C. This implies that when viewed in reflection the TLCs start to reflect red light at 25° C. and blue light at 35° C. and continue reflecting blue for an additional 10° C. up to 45° C. This gives an active range from 25° C. (the event temperature) to 45° C. (the clearing point temperature). The transmission spectra were acquired for a range of temperatures from 20-50° C. The CCD camera spectra was obtained from the manufacturer.

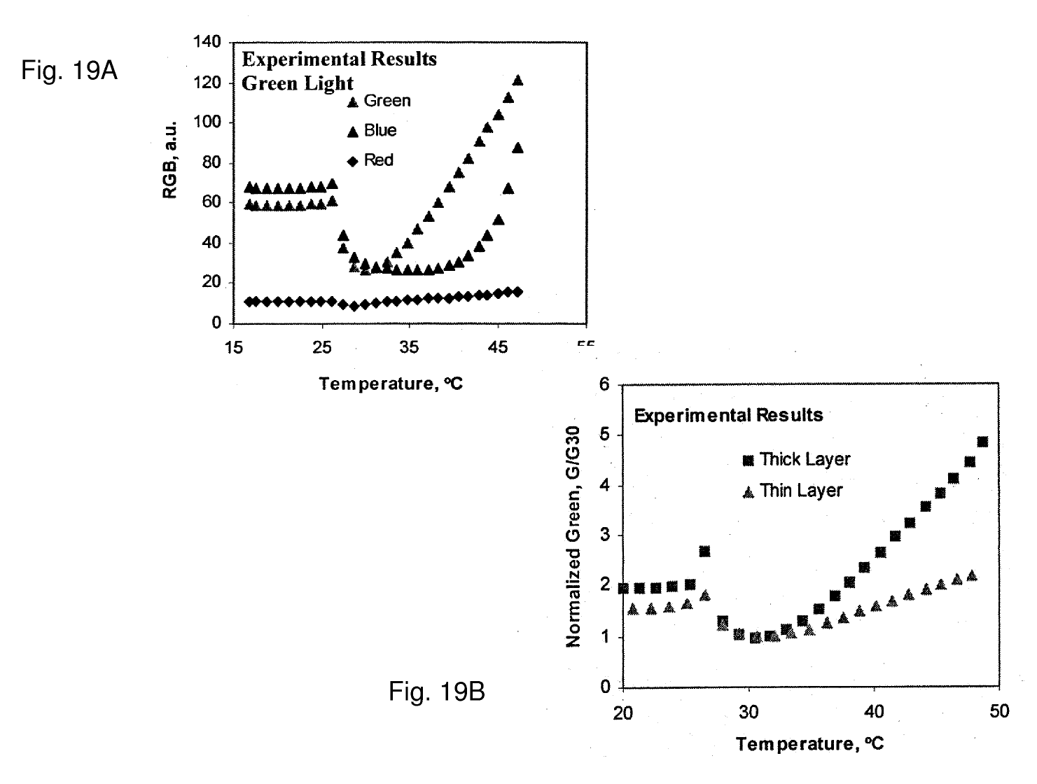

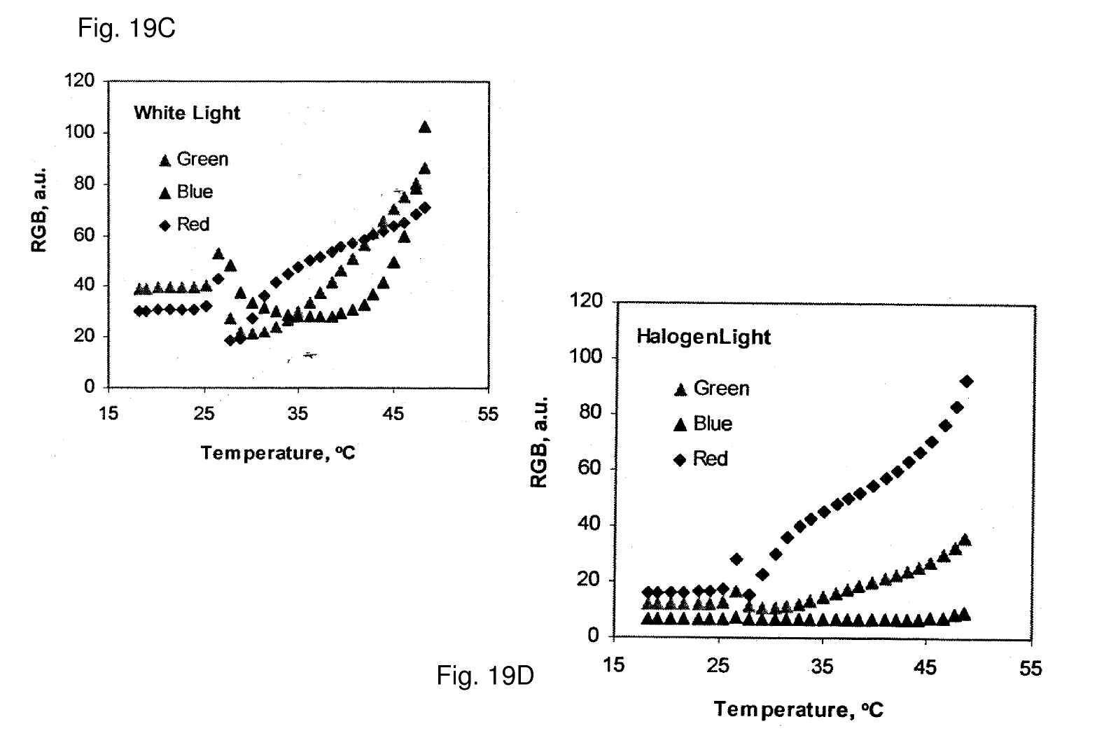

The red, green and blue signals of the CCD camera were predicted for each light source in combination with the liquid crystal layer for temperatures in the range of 24-48° C. and the results are shown in FIG. 19. FIG. 19 shows the predicted green and red signals as a function of temperature for the halogen, white and green lights. As shown, the red and green components are flat for temperatures below the event temperature (25° C.). The levels increase from 25 to 27° C. and then decrease before increasing again as temperature is further increased. This concurs with the spectrophotometer results that showed increasing and decreasing transmission at the low end of the active range. This is also in agreement with predictions made from observing the transmission spectra where it was found that the most significant changes occurred in the wavelength range of green light.

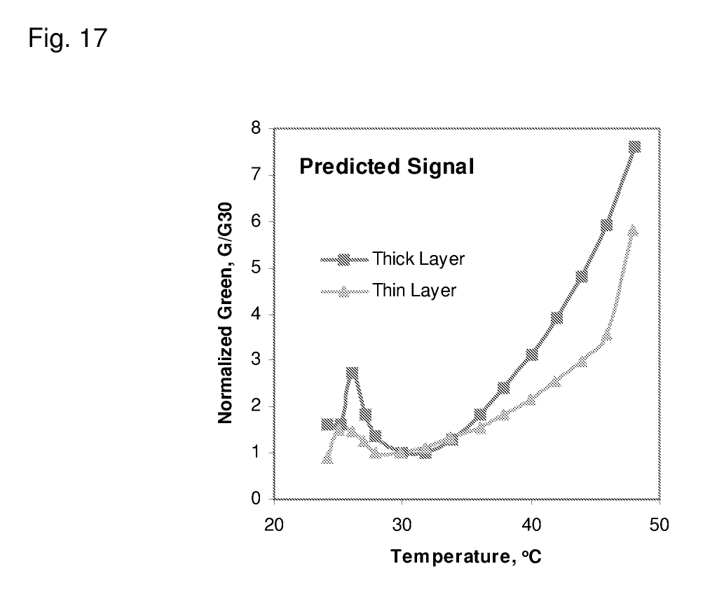

A model was also used to assess the effect of film thickness on output signal. The transmission data was used to predict the green signal for the green light with a thinner layer (0.24 mm) of TLC material. The results are plotted in FIG. 17 and compared to the green signal derived from the thick layer analysis. In this comparison, the green signal is normalized by the green value at 30° C. As can be seen, the thicker layer has a greater change in signal over the given temperature range (a 600% increase for the thick layer versus a 350% increase for the thin layer over the linear range from 30 to 46° C.)

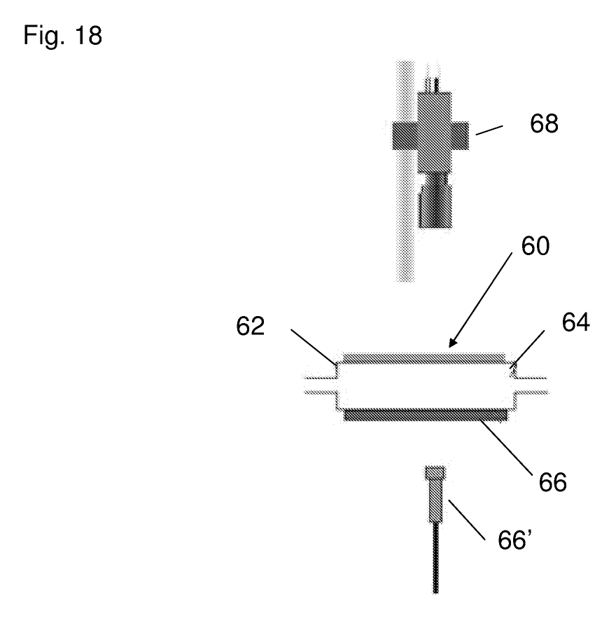

Further testing of the different light sources was accomplished using the apparatus illustrated in FIG. 18. A layer of TLC 60 was applied to an outer surface 62 of a cuvette 64. The TLC material can be Hallcrest R25C10W sprayable crystals having a published event temperature of 25° C. and a bandwidth of 10° C. (clearing point temperature of 45° C.). The cuvette can be a standard 1 cm path length polystyrene cuvette that has been modified to connect to a temperature controlled circulating water path. Calibrated thermocouples (±0.1° C.) were embedded in one side of the cuvette. Thereafter, diluted, filtered TLC material was poured over the thermocouples to form the TLC surface. Two different surfaces were experimented with: a thick layer (˜0.4 mm) and a thin layer (˜0.24 mm).

The cuvette is connected to a temperature controlled water bath system. The bath circulates water through the inside of the cuvette during testing and controls the temperature of the TLC surface. As with the previous spectrophotometer set up, an electroluminescent light source 66 is placed below the cuvette. The light source can be an organic LED, electroluminescent flexible light panel or other similar technology, such as that used in computer and cell phone displays. Light source 66 can be flexible or bendable.

In one embodiment, light source 66 can be a flexible, electroluminescent light attached directly to the bottom side of the cuvette and connected to a power supply (not shown). A halogen light source can also be used as the light source. In such an embodiment, a fiber optic cable can be mounted in line with a CCD camera 68 and spaced below the cuvette, for example 20 cm below the cuvette. CCD camera 68 can be a Sony XC003 3CCD camera to take images of the surface. The camera can also be mounted approximately 20 cm above the test surface.

During testing, the water was slowly heated in the bath (1.5° C./min) and images of the surface as it was heated up. The images were analyzed using MATLAB image processing tools. To check repeatability, the tests were done on the same TLC surface over a period of one week. A standard deviation of ±0.2° C. was calculated.

Referring to FIG. 19A the results from an experimental test using the green electroluminescent light source is shown. For all three components, the signal level is constant for temperatures below 25° C., which is below the event temperature. The signal levels increase from 25 to 27° C. and then decrease from 27 to 30° C. The green signal increase for temperatures above 30° C., the blue signal remains flat until about 40° C. and the red signal is small and flat. The green component is very linear between 30 and 48° C. This linear region is ideal for the development of a temperature calibration to measure temperature. The green signal increases from 25 to 120 a.u. in this linear region, which is close to the 600% change predicted originally. The red and blue components are also qualitatively similar to predicted values. Both the shape and relative values are different due to the gain setting of the CCD camera.

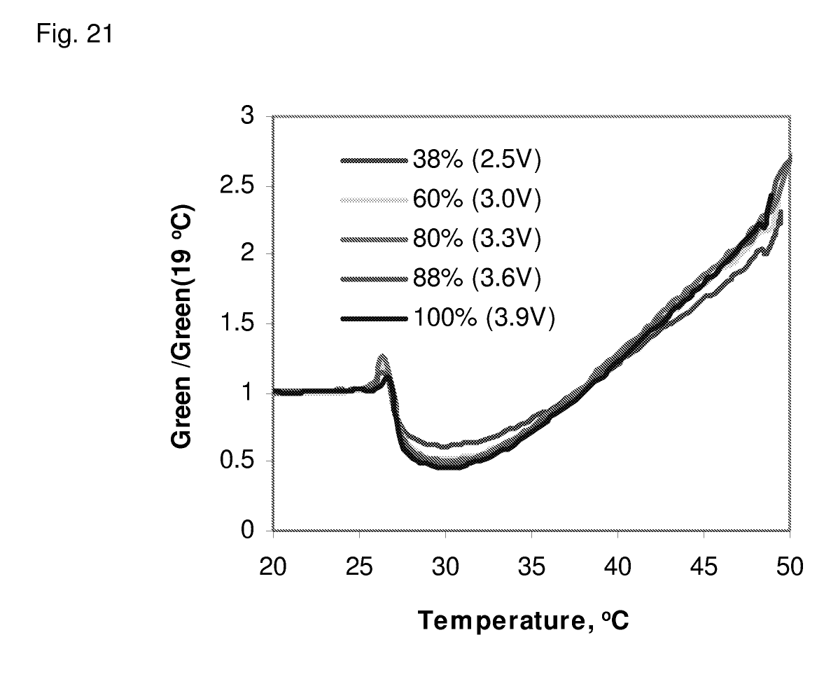

FIG. 19B illustrates the green signal of the thick layer as compared to the green signal of the thin layer for the electroluminescent light. For comparison, both data sets were normalized on the value of the green signal at 30° C. As can be seen, the signal change for the thick TLC layer is more than twice that of the thin layer. This correlates with the results of FIG. 21.

FIGS. 19C and 19D illustrate RBG data for white and halogen lights. As shown, the most significant changes occur for the green component of the white light and the red component of the halogen light.

Based on the experimental results, the green electroluminescent light source is the best for use as a temperature sensor because it is the most sensitive to temperature and the relation is linear.

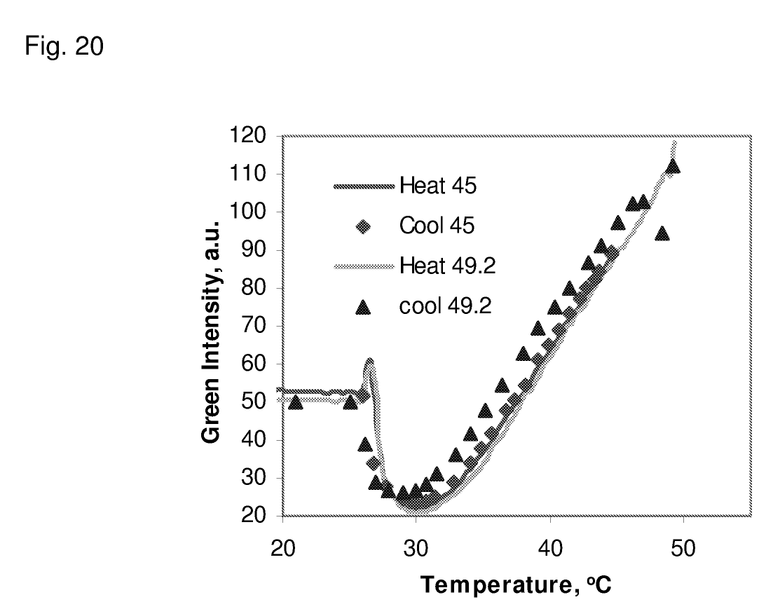

A series of tests were also performed to study the effects of temperature overheat that has been shown to cause hysteresis in data. Images first recorded as the TLCs were heated to 45° C. and then cooled back down. The green signal is shown plotted in FIG. 20. The lines illustrate the heating test and the diamond symbols indicate the cooling data. The heating and cooling data are the same. This indicates that when heated up to 45° C. no hysteresis occurred. However, there is a difference between heating and cooling when the TLCs were heated to 49° C. and than cooled as indicated by the line (heating) and the triangle symbols (cooling) in FIG. 25. The data for heating up to 49° C. follows the 45° C. heating and cooling lines. When the TLCs are heated above 49° C., the green signal levels increase. Once cooled below the event temperature (25° C.) the TLCs returned to their original behavior.

Based on the above results, normalization techniques can be used to generate consistent light intensity output from a light source. The range of variation in light intensity can be determined by varying power to the green light source from 3.9V down to 2.5V, which yields a light intensity that is 38% of the nominal value. Referring to FIG. 21, the green component of transmitted light divided by the green component at 19° C. versus temperature is shown. The 19° C. temperature is outside the active range of the crystals and can be used to account for variation in the light source intensity. The light power can be reduced by 60% (from 3.9V to 3V) before the results start to vary more than 0.2° C. However, when the voltage level drops below 2.5V the signal levels are too low to accurately detect.

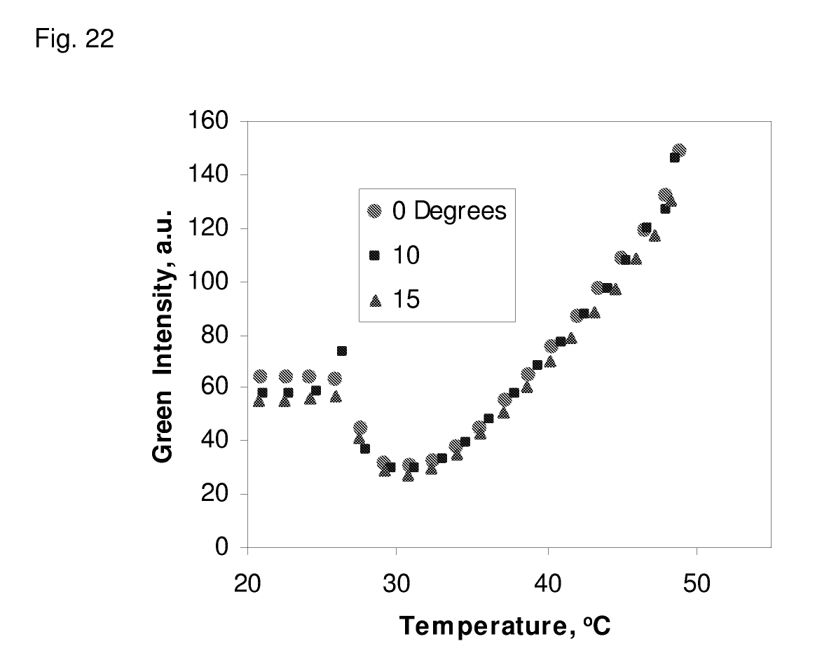

The effect of the camera viewing angle was also measured for 0, 10 and 15 degrees and the results are shown in FIG. 22. The camera viewing angle is defined as zero when the camera and light source are on the same axis. There is no significant variation in the green signal when the viewing angle is changed from 0 to 15 degrees, however beyond 15 degrees the effect is measurable.

The present invention confirms that it is possible to develop a CCD camera based temperature sensor using the transmission properties of thermochromic liquid crystals. Using a linear fit to correlate the green signal with temperature (FIG. 19 data) a resolution of only 0.16° C./unit of green signal results. The calibration for our current surface includes standard deviation values on the order of 2 units of green signal which results in a measurement uncertainty value, due to calibration alone, on the order of +/−0.64° C. (for 95% confidence). However, a higher resolution camera, more advanced image processing and better TLC surface preparation can improve this value. For example, the camera can be optimized to make use of the entire 8 bit (256 levels) or change to a 12 bit CCD camera which will give a much higher resolution (4096 levels). The increased definition would allow for greater temperature sensitivity.

The processing of the raw image recorded by the CCD camera could also be optimized to reduce the variation in signal across the surface. The RGB signal values presented were averaged over a selected region of the TLC surface. The region was chosen for its continuity and intensity of signal. Taking the average of a region dilutes the effects surface thickness non-uniformities. Surface irregularities are common and hard to prevent given the technique used to apply the TLC materials to the surface. Although rigorous filtering of the TLC material before application and the use of an air brush to apply the TLCs could address this issue.

To be able to create a temperature sensor which is effective over an entire surface and not just a selected region, would require more advanced image processing techniques, which use pixel by pixel information, and is contemplated by the present invention. When normalization was used to account for the effects of overall light intensity changes, average values were used and resulting in accounting for variations up to 60% of nominal power levels. Using normalization on a pixel by pixel basis will help to eliminate the variation in TLC material thickness across the surface.

Moreover, if used in transmission mode, it is possible to have the illumination source be part of the temperature sensor as shown in FIG. 14. The TLCs can be sprayed directly onto the electroluminescent lights. This will eliminate many of the problems associated with lining up the light source and camera in reflection. In addition, the use of the electroluminescent lights may offer more lighting uniformity across the surface. The setup of FIG. 14 is able to withstand up to 10 degrees of misalignment in this configuration.

According to the present invention, the use of light transmission instead of light reflection for liquid crystal thermography addresses some of the issues associated with lighting effects and increases the range over which the liquid crystals can be calibrated. By normalizing the signal on an image outside of the active range we are able to collapse data taken at up to 60% of intensity with up to 10 degrees of off axis lighting. Moreover, for the liquid crystals used (Hallcrest R25C1OW) measuring the change in the amount of green light (˜500-560 nm) transmitted through the TLCs offers the most sensitivity and linearity. Thus, an integrated light/TLC sensor may offer more flexibility in the use of liquid crystal thermography.

Although the present invention has been described in relation to particular embodiments thereof, many other variations and modifications and other uses will become apparent to those skilled in the art. It is preferred therefore, that the present invention be limited not by the specific disclosure herein, but only by the appended claims.

What is claimed is:

1. A light transmission based liquid crystal temperature sensor system comprising:
a layer of thermochromic liquid crystals;
a light source for transmitting an amount of light through said layer of thermochromic liquid crystals;
a temperature control device for recording and measuring at least one of the amount and spectral characteristics of the light transmitted through said layer of thermochromic liquid crystals; and
a processing device for recording the measured amount or spectral characteristics of the transmitted light and converting the measurement to temperature.

2. The light transmission based liquid crystal temperature sensor system of claim 1, wherein said light source is flexible.

3. The light transmission based liquid crystal temperature sensor system of claim 2, wherein the layer of thermochromic liquid crystals is disposed on said light source.

4. The light transmission based liquid crystal temperature sensor system of claim 1, wherein said layer of thermochromic liquid crystals is disposed on a surface remote from said light source.

5. The light transmission based liquid crystal temperature sensor system of claim 1, wherein said processing device applies a calibration to convert the measurement to temperature.

6. The light transmission based liquid crystal temperature sensor system of claim 1, wherein the recording and measuring means comprises a CCD camera.

7. The light transmission based liquid crystal temperature sensor system of claim 1, wherein said processing device comprises a microprocessor.

8. The light transmission based liquid crystal temperature sensor system of claim 1, wherein the light source is a halogen light.

9. The light transmission based liquid crystal temperature sensor system of claim 1, wherein the light source is a green electroluminescent light.

10. The light transmission based liquid crystal temperature sensor system of claim 1, wherein the light source is a white electroluminescent light.
